(19) United States
(12) Patent Application Publication
(10) Pub. No.: US 2004/0238794 A1
(43) Pub. Date: Dec. 2, 2004

(54) Microwave processing of composite bodies made by an infiltration route

(76) Inventors: Prashant G. Karandikar, Avondale, PA (US); Michael K. Aghajanian, Newark, DE (US); Luis Ortiz JR., Newark, DE (US)

Correspondence Address: Jeffrey R. Ramberg, Law Office of Jeffrey R. Ramberg, 18 Old Manor Road, Newark, DE, 19711, US

(21) Appl. No.: 10/448,732

(22) Filed: May 30, 2003

(51) Int. Cl. H01B 1/00; C04B 35/52

(52) U.S. Cl. 252/500; 501/88; 501/91; 264/682

(57) ABSTRACT

Metal-ceramic composite materials made by an infiltration technique have now been prepared using microwave energy as the heat source for thermal processing. Specifically, microwave energy has been used to heat and melt a source of silicon metal, which in turn has infiltrated carbon-containing preforms to make reaction-bonded silicon carbide composites, respectively. Both the time-at-temperature as well as the overall thermal cycle time have been greatly reduced, implying a large cost savings.

### STATEMENT REGARDING FEDERALLY SPONSORED RESEARCH OR DEVELOPMENT

This invention was made with Government support under Contract No. DASG60-02-P-0105 awarded by the U.S. Army Space and Missile Defense Agency. The Government has certain rights in the invention.

### BACKGROUND OF THE INVENTION

1. Field of the Invention

The present invention relates to microwave processing of metal and ceramic materials, particularly to composites of metals and ceramics, and most particularly to composites made by an infiltration approach.

2. Discussion of Related Art

At least at some point in the processing of most materials, heating is required. The ability of microwaves to “couple” and thus to transfer energy to certain molecules, most notably the water molecule, is well known. In fact, microwave energy has been used for over 50 years in such applications as communications, food processing, rubber vulcanization, and the drying of ceramic powders. While the heating application of microwave energy, particularly for food, has a long history, the application of microwave heating to processing of materials such as metal, ceramic, and their composites, is more recent.

Microwave processing of materials exhibits a number of advantages over conventional heating. Just as in microwave heating of food products, the obvious advantage is faster heating, which results in improved economics (faster throughput, for example). Other advantages will be described below.

Microwaves are electromagnetic radiation with wavelengths ranging from about 1 mm to about 1 m in free space and frequencies between 300 GHz to 300 MHz, respectively. However, regulation of the electromagnetic spectrum for communications means that very few frequency bands in this range are allowed for research and industrial heating applications. The most common microwave frequency for such applications is 2.45 GHz (λ˜12.25 cm), the same as in domestic microwave ovens; other frequencies are at 915 MHz (λ˜32.8 cm), 30 GHz (λ˜1 cm) and 83 GHz (λ˜3.6 mm) for specific applications. The effect of frequency on the processing of materials is related to the size, volume, and objective of the application. Higher frequency means lower penetration (smaller skin depth) but higher energy, and therefore at frequencies of 30 and 83 GHz one can achieve higher temperatures in absorbing materials much more quickly but in smaller areas. To increase the area of operation high power generators are needed.

In many conventional heating methods, the thermal energy is absorbed on the surface and then it is transferred towards the interior of the part via thermal conductivity; so there is an energy transfer (not conversion) in these methods, and the process is slow. In non-conventional method such as microwave heating, the microwaves are absorbed by the material as a whole (also known as volumetric or bulk heating, a characteristic of the material) due to deep penetration, and then converted to heat via either dielectric loss mechanisms or/and eddy current losses in electrically conducting materials. Since there is an energy conversion, the heating is very rapid. These two processes are fundamentally different in their heating mechanism, and hence can often result in vastly different product.

2.1 Microwave Processing of Inorganic Materials

Microwave processing of inorganic materials dates back to the late 1960's (see, for example, W. R. Tinga, Voss, W. A. G., Microwave Power Engineering, ed E. C. Okress, pp. 189-99, New York, Academic, 1968), generated additional interest in the 1970's, but was not the subject of active research until the 1980's. In particular, microwave heating has been used to sinter inorganic materials, and it is now known that one may use microwave heating to sinter ceramics, metals, intermetallics, ceramic composites, and mixtures of metals and refractory materials, e.g., WC-based cutting tool compositions.

Not surprisingly, most of the early work studying the use of microwave energy to thermally process inorganic materials has focused on ceramics and polymers; it being “common knowledge” that one cannot subject metals to microwaves. Specifically, to anyone who has inadvertently or otherwise placed silverware in a microwave oven, it is well known that metals reflect microwaves and/or cause plasma formation. This phenomenon can be seen in FIG. 1, which attempts to show how microwave absorption typically varies as a function of the electrical conductivity of a material. What this figure expresses is the classic viewpoint that materials with intermediate electrical conductivity, e.g., semiconducting materials, are much more absorbing of microwave energy than are low conductivity (electrically insulating) materials such as traditional ceramics, or high conductivity materials such as metals. The former tend to be transparent to microwaves, while the latter tend to reflect them. However, the purveyors of this common knowledge did not differentiate between bulk metals and metals in finely divided form, such as powders, nor did they take into account the effect of temperature on microwave susceptibility.

2.1.1. Microwave Sintering of Metals

Thus, some of the more recent work has shown that the reflection of microwave energy by metals applies to metals in bulk form, but that powdered metals behave much differently in the microwave field. In particular, they are very efficient microwave energy absorbers; thus, rapid heating of powdered metals can be achieved. In magnetic materials, other manifestations of the microwave coupling include hysteresis losses, dimensional resonances, and magnetic resonances. Among these workers' important conclusions is that the interaction between microwaves and matter involves both the electric field and magnetic field vectors. Additional information can be found in the scientific article by R. Roy, D. Agrawal, J. Cheng, and S. Gedevanishvili, “Full sintering of powdered metals parts in microwaves”, Nature, 399, 664 (Jun. 17, 1999). Thus, and in a major break from past theory, these researchers were able to show that all finely divided metallic materials absorb microwave energy.

With specific regard to the practical applications of this discovery, various metals and metal alloys, some of which are very commonly used in powder metallurgy, have been sintered using microwave energy from the “green” state. Only a short period of time, on the order of 15 to 30 minutes at the soak temperature, typically between 1100° C. and 1300° C., is required to produce a substantially fully dense body in a controlled-atmosphere microwave furnace operated at a frequency of about 2.45 GHz. The physical properties of microwave sintered metals usually differ in one or more respects from their counterparts sintered by the traditional route. For instance, certain mechanical properties such as hardness and Modulus of Rupture (MOR) are almost always higher in value than those sintered by traditional heating. See, for example, R. M. Anklekar, D. K. Agrawal, and R. Roy, “Microwave Sintering and Mechanical Properties of P/M Steel”, Powder Metal. Vol. 44[4], 355-362 (2001). Transmission Electron Microscopy confirms differences in microstructure and grain boundary chemistry, suggesting that microwave processing involves some non-thermal phenomena. Not only has microwave sintering of powdered metals been achieved, but so has the synthesis of intermetallic compounds using microwave heating. See, for example, S. Gedevanishvili, D. Agrawal, and R. Roy, “Microwave combustion synthesis and sintering of intermetallics and alloys”, J. Mat. Sci. Lett, 18, 665-668 (1999).

2.1.2. Microwave Sintering of Ceramics

Among the most prominent advances in this category include the sintering of most common white ceramics (alumina, mullite, apatite, etc.) to full density, in some cases leading to transparency in 30 minutes or less. See, for example, J. Cheng, D. Agrawal, Y. Zhang, B. Drawl and R. Roy, “Fabricating Transparent Ceramics by Microwave Sintering,” Am. Cer. Soc. Bull. 79 (9) 71-74 (2000). Completely transparent ceramics of hydroxyapatite, an important bio-material, have been successfully fabricated using microwaves in a matter of a few minutes. See, for example, Y. Fang, D. K. Agrawal, D. M. Roy and R. Roy, “Fabrication of Transparent Hydroxyapatite Ceramics by Microwave Processing” Mater. Lett. 23, 147-51 (1995). Oxide ceramic composites with ZrO₂ as a primary phase were also sintered in a microwave field with improved density. See, for example, Y. Fang, J. Cheng, R. Roy, D. M. Roy and D. K. Agrawal, “Enhancing Densification of Zirconia-containing Ceramic-Matrix Composites by Microwave Processing,” J. Mat.Sci, 32 4925-4930 (1997). In most cases, microwaves reduced sintering time by a factor of 10 to 20, minimized the grain growth and improved mechanical properties. See also the review article by D. K. Agrawal, “Microwave processing of ceramics: A review,” Current Opinion in Solid State & Materials Science, 3 (5), 480-86 (1998).

2.1.3. Microwave Sintering of WC-Composites

As has been published in, for example, J. P. Cheng, D. K. Agrawal, S. Komarneni, M. Mathis, and R. Roy, “Microwave Processing of WC-Co Composites and Ferroic Titanates,” Mat. Res. Inno., 1, 44-52 (1997), the applicability of microwave sintering to the entire range of tungsten carbide/cobalt (WC/Co) based cutting tool composites likewise has been demonstrated. Compared to traditional sintering, cycle times were reduced from 24-36 hours to about 90 minutes. As with microwave sintered metals, the mechanical and wear resistant properties are all improved compared to conventional heating. Further details regarding the microwave sintering of the above-mentioned materials also can be found in U.S. Pat. Nos. 6,004,505; 6,183,689 and 6,512,216.

The entire contents of each of the above-mentioned Patents and Publications is hereby incorporated by reference.

Thus, the benefits of microwave sintering over conventional sintering can be summarized as follows:

High heating rates (>400° C./minute)

Uniform and volumetric internal heating/cooling reduces probability of thermally induced stresses in complex parts

Rapid nucleation, rapid diffusion, enhanced reaction kinetics and resultant enhanced sinterability, which can permit reduced sintering time and temperature

Finer microstructures

Synthesis of new and special materials

Time and energy savings

A uniform microwave field makes it possible to heat both small and large shapes very rapidly, uniformly, and efficiently. This is important in case of sintering metal-based products where undesired grain growth can be prevented by rapid heating and short sintering periods. All of these possibilities have the potential of greatly improving mechanical properties and the overall performance of the materials, with the added benefit of low energy usage and cost. Due to the internal heating in the microwave processing, it is possible to sinter many materials at a much lower temperature and shorter time than required in conventional methods. The use of microwave processing reduces typical sintering times by a factor of 10 or more in many cases, thereby minimizing grain growth. Thus, it is possible to retain the initial fine grain structure without using grain growth inhibitors.

Despite the enhancement in diffusion kinetics using microwave heating, the conventional sintering technology has some inherent limitations. First, sintering always involves the shrinkage that is associated with the expulsion of porosity from the porous green body during densification. The shrinkage is proportional to the amount of porosity to be eliminated. Compared to materials processed by an infiltration route, for example, these shrinkages are very large, and are therefore very difficult to “factor in” so as to end up with a densified part that meets its dimensional tolerances. Another problem, at least with traditional sintering, is that the size of the parts being sintered is limited because it is nearly impossible to thermally process large parts such that they sinter at the same rate in the various regions on and in the part. The result of these differential sintering rates is the almost inevitable formation of cracks in the part. Microwave sintering can eliminate this problem if a suitable microwave cavity combined with insulation package is designed to obtain uniform energy distribution throughout the size of the work piece. However, such designs are dependent upon the sintering temperatures and material coupling in microwave fields.

Thus, there are product areas that require the fabrication of large parts that are not conducive to being sintered, and/or require parts whose dimensional tolerances are difficult to meet using a sintering approach. It is these parts where the infiltration techniques of the present invention are often appropriate.

Thus, one of the objectives of the present invention is to try to translate the advantages of microwave sintering to infiltration-based composite processing.

2.2 Composite Materials by Infiltration

A number of commercially valuable metal-ceramic composite materials are made by an infiltration route. Among the more interesting of these are those that do not require large applications of pressure, such as is required for the so-called squeeze casting technique.

2.2.1 Reaction-Bonded Silicon Carbide

Among those infiltration processes that have been around for decades is that of silicon melt infiltration, whereby molten silicon metal is caused to infiltrate a porous mass of ceramic material such as silicon carbide or silicon nitride. In one common variation of this basic process, the porous mass, which is often silicon carbide particulate, also contains a quantity of carbon. A variety of carbonaceous precursors can be used to introduce this carbon into the preform such as pitch, phenolics, furfuryl alcohol, carbohydrates such as sugars, etc.

Next, the preform containing the reinforcement and the precursor is “carbonized” in an inert atmosphere above 600° C. to convert the precursor to carbon. Finally, the preform is placed in contact with a molten infiltrant material featuring Si metal or alloys of Si in an inert or vacuum atmosphere and heated to above the melting point of the infiltrant material. Due to spontaneous wetting and reaction between carbon and molten Si, the preform is infiltrated completely. The carbon in the preform reacts with the Si, forming SiC, and in the process bonds the reinforcement together. Some residual infiltrant material remains distributed throughout the formed composite body. Such composites are termed “reaction-bonded SiC”, although such terms as “self-bonded SiC”, reaction forming”, “reactive sintering”, etc., are also abundant in the literature. Many embodiments of the reaction bonding process are in the public domain. However, in recent years, this process has been further enhanced by M Cubed Technologies, Inc. (“M Cubed”) for making Si/SiC composite bodies that optionally feature different or additional reinforcements such as boron carbide or carbon fibers, or feature one or more alloying elements such as aluminum, copper, molybdenum, boron, etc. See, for example, U.S. Pat. Nos. 6,355,340 to Singh et al., and 6,503,572 to Waggoner et al., and PCT Publication No. WO 02/068,373, the contents of which are expressly incorporated herein in their entirety by reference. Other patents are pending.

M Cubed currently makes components using reaction bonding that may weigh in excess of 250 kg and may have dimensions in excess of 1 meter. The shrinkage from the perform stage to the final, infiltrated stage is less than 0.5%, allowing net-shape component fabrication. Also, the carbonized performs can be green machined to high tolerances and bonded together to make complex shapes, ribbed structures, box structures, cooling channels, etc.

A significant number of components have been manufactured successfully to near net shape by M Cubed processes. Their technical merit has been proven in almost all applications. However, so far, market penetration has been achieved only in high-value-added commercial products. In particular, in the case of reaction bonding, slow heating and cooling is required during fabrication of large, complex components to minimize thermal stresses related to temperature gradients. In addition, potential exists for improving the microstructure, reaction kinetics, and mechanical properties.

In view of the volumetric heating of microwaves (as opposed to surface heating conventionally), it may be possible to heat an infiltration-type lay-up faster using microwave heating, while avoiding cracking the preform due to temperature gradients.

Thus, a significant potential exists for accelerating these infiltration processes via the use of microwave energy.

Further, in view of the many benefits that microwave processing has on sintering of inorganic materials, it is worth trying to apply microwave energy to the composite densification process where the densification is accomplished by infiltrating one or more metals into a porous preform and in a pressureless manner.

### OBJECTS OF THE INVENTION

Thus, in view of the present state of materials development, it is an object of the present invention to produce a metal-ceramic composite material by an infiltration route, and in particular one in which microwave energy is used to assist the composite formation process.

It is an object of the present invention to try to speed up the total cycle time required for thermal processing of composites made via infiltration.

It is an object of the present invention to explore, what changes, if any, microwave processing may have on microstructure and/or physical properties of the formed composite body.

### SUMMARY OF THE INVENTION

These and other objects of the present invention are achieved by using microwave energy to supplement or replace conventional heating in the composite densification-by-infiltration process.

Metal-ceramic composite materials made by an infiltration technique were prepared using microwave energy for the thermal processing. In particular, that category of metal-ceramic composite material known as “reaction-bonded silicon carbide” has been prepared where the energy source for thermal processing was provided exclusively from a microwave source. In accordance with a preferred embodiment of the instant invention, an assembly or “lay-up” for infiltration was prepared by contacting the silicon-based metal to be infiltrated, which can be in bulk, powder or “chunk” form, to one surface, typically a bottom surface of a porous preform of ceramic material to be infiltrated, and then supporting or housing this preform/metal pair in a refractory container, such as a boron nitride or BN-coated alumina crucible. The assembly consisting of the refractory crucible and its contents was then placed inside the insulation package of the microwave cavity. The atmosphere in the cavity was evacuated until a condition of high or “hard” vacuum was achieved. The 2.45 GHz microwave generator was energized, and microwaves were directed from the generator into the cavity through a waveguide. Heating was achieved entirely by the conversion of the microwave energy. The silicon-based infiltrant metal was heated above its liquidus temperature, and the molten metal infiltrated the porous preforms and reacted with the carbon component of the preform to make a silicon carbide matrix RBSC composite body, respectively. Test coupons of this composite material system were prepared, and selected properties were measured. The time-at-temperature as well as the overall thermal cycle time has been greatly reduced compared to what is required using conventional heating, leading to substantial savings in energy and time, thereby reducing the processing cost. Still, the microstructure and physical properties of the RBSC composite bodies made using microwave energy appear to be substantially the same as for those made using conventional heating. Further, it was noted that the silicon infiltrant metal could be provided to the lay-up in bulk form, and heated to the processing temperature solely using microwaves as an energy source.

### DEFINITIONS

“MASS”, as used herein, means Microwave-Assisted materials processing.

“RBSC”, as used herein, means reaction-bonded silicon carbide.

### BRIEF DESCRIPTION OF THE FIGURES

FIG. 1 is a graph that approximates microwave power absorption of a bulk material as a function of the material's electrical conductivity.

FIG. 2 is a schematic of the microwave assisted process for making composites by infiltration;

FIG. 3 is a more detailed schematic illustration of that portion of FIG. 2 showing the components housed within the microwave cavity;

FIG. 4 is a photograph of a test coupon of Si/SiC composite material made by microwave-assisted reaction-bonding (MASS RB);

FIG. 5 is an approximately 800× optical photomicrograph of a Si/SiC composite made by MASS RB; and

FIG. 6 is an SEM photo of fracture surface of Si/SiC composite made by MASS RB.

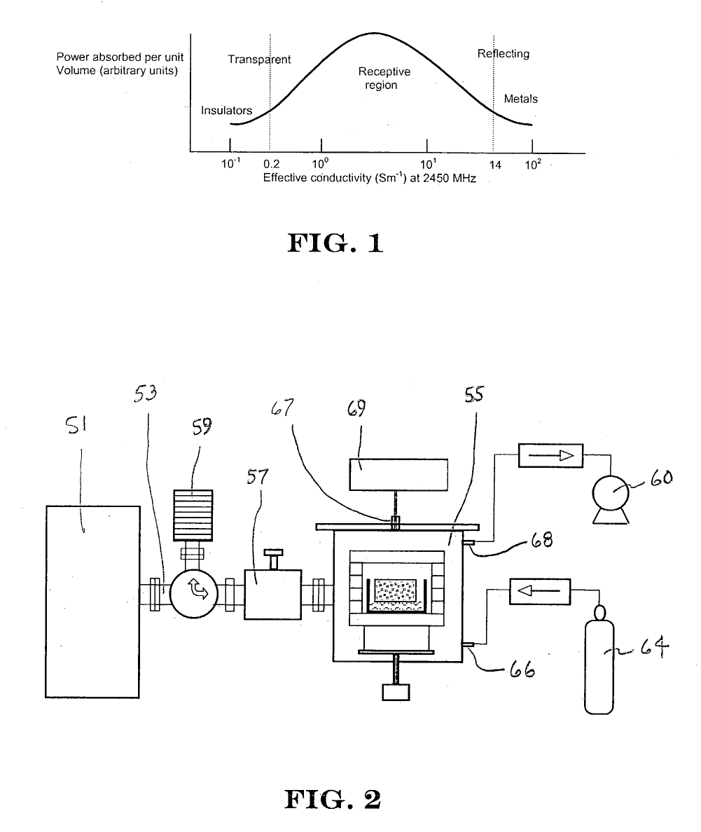

### DETAILED DESCRIPTION OF THE INVENTION AND PREFERRED EMBODIMENTS

According to the present invention, composite bodies made by infiltrating a molten metal into a porous preform now can be made using microwave heating, either as a supplement to, or a complete replacement of, conventional heating. The heating source for the thermal processing of the composite material systems was provided by a microwave heating apparatus originally designed and built by Penn State researchers to investigate microwave sintering. This apparatus had to be modified somewhat to render it useful for the present infiltration work. Specifically, although the RBSC process can be conducted in an inert atmosphere, the instant inventors preferred to use a vacuum environment. While the microwave cavity, or at least that portion housing the lay-up, was capable of supporting a modest vacuum, it had to be modified to accommodate a high vacuum environment.

Referring to FIG. 2, the generator or source 51 of the microwaves was simply a commercially available microwave generator (Cober Electronics) capable of producing microwaves at a frequency of about 2.45 GHz and at a maximum power of about 6 kilowatts. This generator is an industrial unit used for many applications in food, wood, and pharmaceutical industries. The frequency of 2.45 GHz is a common one for microwave heating applications. The microwaves were conducted along a copper/aluminum/steel tube 53 called a microwave waveguide toward and into a cavity 55 that served as the heating/processing chamber, and is known as microwave cavity or applicator. Attached to the waveguide was a tuning apparatus 57 and a water circulator/load 59. A quartz window 67 was located at the top of the microwave cavity so that an optical pyrometer 69 could be focused on the preform for a temperature monitoring. The temperature was controlled by manually adjusting a rheostat on the power controller of the microwave source in response to the temperature reading. To control the atmosphere within the microwave cavity, gas 64 may be supplied through entrance port 66, and evacuated through exit port 68 by means of pump 60. Thus, cavity 55 is capable of creating a desired atmosphere or low vacuum depending upon the needs.

Referring now also to FIG. 3, which shows a more detailed view of microwave cavity 55, and in particular a microwave cavity that has been modified to accommodate the high vacuum requirements for conducting a RBSC infiltration, assembly 52 consists of infiltrant metal 34 in contact with porous preform 36, each being supported by dense alumina crucible 38 coated on its interior surfaces with boron nitride “paint” 50. The assembly in turn was placed on a pedestal 54, which in turn was supported by the bottom flange of a pair of flanges. Both bottom flange 56 and top flange 58 created a seal with quartz tube 31, thereby creating a hermetic environment that could be evacuated to a high degree of vacuum by means of a vacuum pump operating through vacuum port 33. (Port 37 is a vacuum relief port.) The upper flange featured the quartz window 67 for optical pyrometry and general monitoring of the infiltration run. Thermal insulation 35 made from aluminosilicate-based fibers surrounded the lay-up to prevent the heat loss from the surface of the work-piece. This insulation is microwave transparent at temperatures less than 1500° C. The illustration shows all of these items being housed within the microwave cavity; however, it may be the case that only the items to be heated need to be within the cavity.

Many of the preforms infiltrated in the present work featured silicon carbide as a constituent, which readily suscepts (absorbs) microwave energy, thereby converting it to heat. If the preform, infiltrant metal or other component of the assembly does not absorb the microwave energy at room temperature, microwave susceptor bodies such as silicon carbide are provided in proximity to the assembly to assist in the heating. The idea is that by placing the susceptor body or bodies close to or adjacent the assembly, the susceptor material will convert the absorbed microwave energy to heat, and in turn heat its surroundings by radiation, conduction, etc. In one embodiment, the susceptor material may take the form of a number of SiC rods oriented vertically and placed in selected locations around the perimeter of the assembly.

The basic infiltration process is not negated by the substitution of microwave heating for conventional heating. Essentially, a source of molten metal, e.g., silicon-containing metal, is contacted to a porous mass of one or more reinforcement materials, e.g., silicon carbide, under conditions whereby the molten metal can wet at least one constituent of the porous mass, which then draws the molten metal into the mass by capillary action. One or more constituents of the molten metal may chemically react with one or more constituents of the porous mass.

The porous mass must be permeable at least to the molten metal that is to infiltrate it to produce a composite body. The porous mass also should be sufficiently permeable to any infiltrating atmosphere or vacuum that might be used. In general, the size and amount of the reinforcement or filler material may be any that is consistent with these permeability requirements. With conventional heating at least, infiltration has been successfully conducted through porous masses of particulate where the particle size ranged from micron-sized bodies to several millimeters; however, particle sizes in the range of about 10 to 300 microns are more typical. It may be possible, particularly using microwave heating, to infiltrate porous masses of filler containing nanometer-sized bodies, e.g., nanoparticles, nanotubes, etc. Similarly, the filler loading in the porous mass may range from about 10 percent by volume up to perhaps 90 percent, although it should be possible to conduct the reaction-bonding process through porous masses of even lower loading, e.g., as low as zero percent loading (that is, only carbon reactant and no filler). The precise cut-off at the upper end of the range will depend upon the point at which the pores start to close off. A closed pore cannot be infiltrated.

The porous mass is generally provided in self-supporting form, e.g., as a preform. It may be a reticulated structure, may contain continuous fibers, which may be woven or not, may contain discontinuous or discrete bodies of filler material, or some combination. Preforms consisting of discontinuous bodies such as particulate are popular because of the number of processing options available such as various pressing techniques or liquid phase molding techniques (e.g., slip casting, sediment casting, injection molding, etc.). Usually, a temporary binder is included in the preform-making ingredients to impart sufficient strength after forming the desired shape to permit handling. An important feature of infiltration techniques as compared to sintering techniques for composite densification is the very small dimensional change upon densification. Thus, one can perform machining operations on the body at the preform stage when material removal is relatively easy, and the machining details will be of the correct size and shape upon densification. Such machining is termed “green machining”.

Usually, the temporary binder is removed before or during the thermal processing of densification (infiltration). Sometimes, however, it is desirable to provide to the preform a “permanent” binder, which may be the same or different from the temporary binder, that remains in the preform and continues in its bonding function even as the preforms are beginning the infiltration step. Sometimes the permanent binder can be the same substance as the temporary binder, with the only difference being in how the respective binders are processed, e.g., whether the atmosphere during thermal processing is oxidizing or non-oxidizing. An example of a permanent binder that is popular for use in preforms that are to be infiltrated with silicon is carbon. Such a binder typically is added to the preform-making ingredients as a carbonaceous resin such as phenolic, furfuryl alcohol or a carbohydrate such as a starch or sugar. A preform made by a liquid phase processing technique such as slip casting may then be heated in a non-oxidizing atmosphere such as nitrogen to a temperature sufficient to drive off the liquid and pyrolyze the resin to substantially pure carbon. Then, during the thermal processsing of infiltration, this carbon usually reacts with the infiltrating silicon to form silicon carbide in-situ in the resulting composite body. Traditionally, the in-situ silicon carbide is produced in sufficient quantity that it forms a network that bonds any filler that may be present, which traditionally consists of silicon carbide particulate; thus, the term “reaction-bonded silicon carbide” or “RBSC” to denote this class of composites.

The reinforcement or filler material (these terms are interchangeable for purposes of this disclosure) is intended to include materials that are, or are rendered (e.g., through one or more protective coatings) substantially non-reactive with and/or of limited solubility in the infiltrant metal, and may be single or multi-phase. Filler materials may be provided in a wide variety of forms, such as flakes, platelets, whiskers, fibers, particulates, chopped fibers, spheres, pellets, tubules, nanotubes, nanoparticles, etc., and may be either dense or porous. Filler materials can be metals or intermetallic compounds or elements such as carbon in its various forms, e.g., diamond, but ceramic materials, particularly refractory ceramics, are popular choices. Such materials include oxides (e.g., Al₂O₃, MgO), carbides (e.g., SiC, WC), borides (e.g., AlB₁₂, TiB₂), nitrides (e.g., AlN, Si₃N₄) and complex ceramic compounds (e.g., MgAl₂O₄, oxycarbides, carbonitrides, etc.). Filler materials may also include coated fillers such as carbon fibers coated with silicon carbide to protect the carbon from attack, for example, by a molten silicon infiltrant metal.

The form of the infiltrant metal does not appear to be critical in this microwave heating approach. In the traditional reaction-bonding process, the silicon metal is often provided in particulate, aggregate or “chunk” form. However, it should be possible to provide the silicon metal in bulk form with no adverse effects on the process or equipment or resulting composite materials, e.g., arcing or plasma formation.

As mentioned above, the microwave heating apparatus, originally designed for sintering, had to be modified somewhat, particularly for the reaction-bonding process, mostly to enable it to accommodate vacuums better than what a mechanical “roughing” pump can achieve. The reaction-bonding process works best in a non-reactive atmosphere, such as inert gas or vacuum. Using conventional heating, it has been observed that infiltrations that are conducted below a temperature of about 1500° C. work better in a vacuum environment rather than at an atmospheric pressure of inert gas. Since it was observed in other infiltration systems, however, it may also be the case that microwave heating imparts greater infiltrating power to the silicon-based infiltrant in RBSC composite systems, and thus it may be possible to achieve robust infiltrations at the low temperatures (<1500° C.) at atmospheric pressure in, for example, an argon atmosphere. In the initial investigative work represented herein, the inventors preferred to continue using a vacuum environment, largely because of the known robustness of infiltration under these conditions, and because of their greater experience in conducting these infiltrations in vacuum rather than in inert gas.

Using conventional heating, a vacuum that can readily be achieved using a mechanical “roughing” pump, for example, in the range of about 100-200 mTorr, is all that is required to prevent oxidation of the molten silicon with gas molecules, thereby permitting robust infiltration to make RBSC. Using microwave heating, however, this gas pressure range will lead to ionization of the gas and thus plasma formation, which is not conducive to effective heating. At lower pressures, the amount of plasma is similarly reduced, or possibly eliminated altogether; thus, it was advantageous in the present invention to conduct the microwave heating in high (“hard”) vacuum, for example, at a pressure no greater than about 50 mTorr. This meant that the roughing pump required assistance from a high vacuum pump, such as a diffusion pump or ion pump.

The following example illustrates with still more specificity several preferred embodiments of the present invention. This example is meant to be illustrative in nature and should not be construed as limiting the scope of the invention. Unless expressly mentioned otherwise, all of the reinforcement materials making up these composites were provided in particulate form, which also may be indicated by the subscript “p”.

### EXAMPLE

This example demonstrates the production of an Si/SiCₚ composite made by a reaction-bonding process using microwave heating.

First, a preform beam measuring about 0.64 cm square by about 5.7 cm long was prepared by a sedimentation casting technique. Specifically, SiC particles (a mixture of 240 and 500 grit) were mixed with about 20 parts de-ionized water and about 8 parts of crystalline fructose (Krystar 300, A. E. Staley Mfg. Co., Decatur, Ill.) to make a slip. The slip was poured into a rubber mold. The rubber mold was placed on a vibrating table for about 3 hours. The supernatant liquid was removed and the mold was placed in a freezer for about 3 hours. Nekt, the preform was demolded and bisque fired in an inert atmosphere furnace to a maximum temperature of about 650° C., thereby carbonizing the fructose. The bisque fired perform was about 70 percent by volume loaded in SiC.

To assemble the components for reactive infiltration, this preform 36 was placed in a vertical orientation in a boron nitride-coated alumina crucible 50, 38 measuring about 25 mm in diameter by about 60 mm in depth (please refer again to FIG. 3). About 26 g of silicon 34 in small aggregate form was placed around the base of the preform 36 to complete the assembly 52.

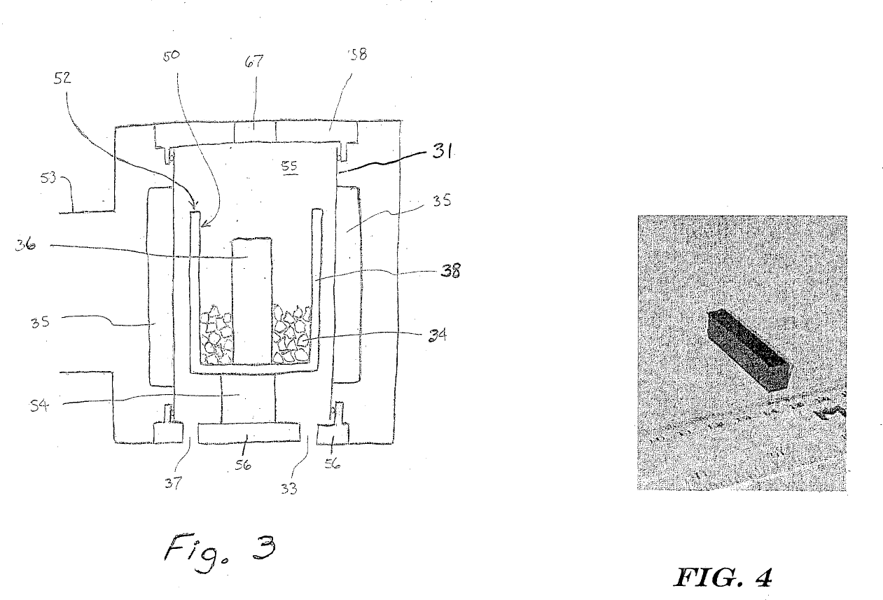

The crucible and its contents was then placed inside a quartz tube 31 that was situated in the microwave cavity 55. The quartz tube was then evacuated to a residual pressure of about 20 mTorr. The microwave power was then gradually raised from zero to about 0.5 to 1 kW. The temperature of the preform was monitored by an optical pyrometer. The microwave power was adjusted to obtain a constant temperature of about 1450° C. Once at this processing temperature, the infiltration process was allowed to proceed for about 60 minutes. After this time, the microwave power was turned off, and the furnace was permitted to cool naturally. When the part had cooled to below about 50° C., the apparatus was disassembled and the crucible was removed, revealing that a fully infiltrated, fully dense silicon/silicon carbide composite body had been formed. The run was repeated to produce a second such composite body to have enough material for characterization. FIG. 4 is a photograph of one of the beams of Si/SiCₚ composite material made by microwave-assisted reaction-bonding (MASS RB).

Thus, a 5.7-centimeter long preform was fully infiltrated lengthwise in about 1 hour using microwave heating. The heat up and cool down each took about 0.5 hour. Under conventional conditions, infiltration would require about 2 hours and heating and cooling would need about 8 hours. In other words, the process time was reduced to one fifth of original time, or an approximately 80% reduction.

In addition to demonstrating that RBSC composites can be produced in a high vacuum environment using microwave energy as the exclusive heating source, this example furthermore demonstrates that this system does not require heating supplements such as the strategically placed susceptor bodies to assist with proper absorption of microwaves and heating thereby. Since the glass tube used to create the vacuum environment is highly transparent to microwaves, this example furthermore illustrates that only the lay-up or assembly has to be placed in the vacuum environment, and that the rest of the apparatus, e.g, microwave generator, waveguide and cavity, can be at ambient pressure in air.

Chemical, Microstructural and Mechanical Characterization

Test specimens were machined from the composite beams, and subjected to physical, chemical, microstructural and mechanical characterization. Physical characterization included density measurements and visual observations for cracking, porosity etc. The densities of the test samples were determined using Archimedes' principle per ASTM Procedure C373. Specimen elastic modulus measurements were made by an ultrasonic measurement technique. The flexural strength were determined using a four-point or three-point bend testing fixtures on an Instron universal testing machine per ASTM Procedure C1161. These properties are as follows:

| | |
|---|---|
| Density (g/cc): | 3.005 |
| Elastic Modulus (GPa): | 352 |
| Flexural Strength (MPa): | 176 ± 11 |

The density value of the Si/SICₚ composite compares well with that calculated based on rule-of-mixtures. The modulus value compares very well with that of the conventionally processed RBSC composite.

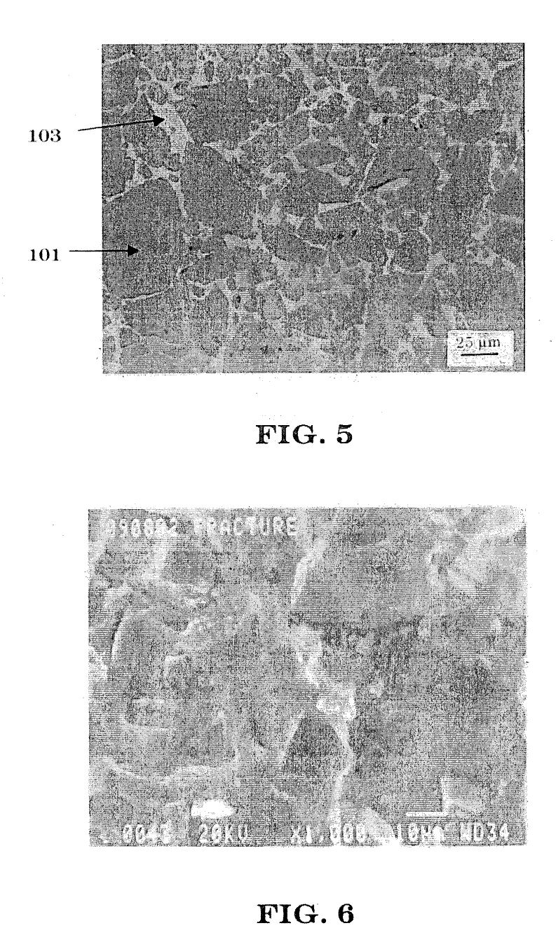

For microstructural observations, specimens were sectioned and polished and observed by optical and scanning electron microscopy. In particular, FIG. 5 is an approximately 800× micrograph of the reaction-bonded SiC composite material, showing SiC 101 as the darker gray phase, and residual Si metal 103 as the lighter phase. Much of the SiC derives from the particulate provided to the preform, and although it still appears as discrete particles, a small amount of this SiC is formed in-situ, and takes the form of a tenuous network, lightly interconnecting the SiC particles of the preform.

The fracture surfaces of mechanically tested specimens were evaluated using electron microscopy to determine the failure modes. FIG. 6 shows the fracture surface of the reaction-bonded SiC composite made using microwave heating. Trans-granular fracture of the reinforcement was observed, which shows that a strong particle-matrix bond was achieved by microwave-assisted processing, just as for a similar RBSC composite made using conventional heating.

### Industrial Applicability

Substantial process benefits were obtained due to microwave assistance in a reaction bonding process. Under microwave assistance, the heat up rate (to melt the infiltrant and reach process temperature) and cool down rates were much faster than for conventional processing that relies on surface heating. Generally, the process temperatures were reached in about 30 minutes. Parts also cooled in about 30 minutes after turning off the microwave power. An approximately 80% reduction in processing time was realized, in comparison to that required using conventional heating.

The present invention demonstrates the utility of using microwave energy to thermally process materials to produce useful metal-ceramic composites. In some instances, the microwaves appeared to impart greater robustness or infiltrating ability to the molten metal, which could be useful in infiltration systems where infiltration is difficult to achieve, or to achieve to completion, thus opening up the possibility of making new composite material systems by infiltration. In general, however, the metal-ceramic composite bodies produced appear to possess the same properties as similar bodies made by conventional heating.

The present invention demonstrates that a microwave energy source can heat the components of a metal infiltration system much more quickly than can be achieved in conventional heating arrangements, thereby producing composite bodies in a shorter time and with less energy.

It should be possible to apply the techniques taught herein to other similar silicon-based infiltration systems, such as systems based upon a boron-containing substance as the reinforcement, e.g., boron carbide, or to systems based upon carbon fiber as the reinforcement, or to systems based upon infiltrants containing constituents in addition to silicon, such as aluminum, copper, molybdenum, etc. It should also be possible to apply microwave heating to other infiltration-based composite systems to make, for example, glass-ceramic or glass matrix composites by the infiltration of highly fluid glass compositions into preforms containing fillers or other reinforcement.

An artisan of ordinary skill will appreciate that various modifications may be made to the invention herein described without departing from the scope or spirit of the invention as defined in the appended claims.

1. A method for making a silicon carbide composite material, comprising:
providing a porous mass comprising at least some carbon;
providing an infiltrant material comprising silicon;
heating said infiltrant material in a non-reactive environment to a temperature above the liquidus temperature of said infiltrant material to form a molten infiltrant material, at least a portion of said heating being provided by microwave energy;
communicating said molten infiltrant material into contact with said porous mass;
infiltrating said molten infiltrant material into said porous mass, and reacting at least a portion of said silicon with at least a portion of said carbon to form a composite body comprising silicon carbide and a residual, unreacted quantity of said infiltrant material, and maintaining said microwave energy during at least a portion of said infiltrating and reacting.

2. The method of claim 1, wherein at least said porous mass and said infiltrant material are arranged in an assembly comprising a refractory container that houses at least said porous mass and said infiltrant material.

3. The method of claim 2, further comprising providing at least some thermal insulation around at least a portion of said assembly.

4. The method of claim 3, wherein said thermal insulation is highly transparent to said microwave energy.

5. The method of claim 1, wherein said microwave energy comprises waves that are predominantly at a frequency selected from the group consisting of about 915 MHz and about 2.45 GHz.

6. The method of claim 1, further comprising providing a means for controlling the power of said microwave generator.

7. The method of claim 1, further comprising a means for monitoring the temperature of the assembly.

8. The method of claim 1, wherein at least said porous mass and said infiltrant are located in a microwave cavity, and wherein said microwave energy is provided by a microwave generating source, and further wherein said microwaves are transmitted from said source to said cavity through a wave guide.

9. The method of claim 2, wherein said heating is enhanced or assisted by placing at least one microwave susceptor body near said assembly, said susceptor body being capable of absorbing microwave energy.

10. The method of claim 9, wherein said microwave susceptor body comprises silicon carbide.

11. The method of claim 1, wherein said porous mass contains from a trace amount up to about 10 percent by volume of said carbon.

12. The method of claim 1, wherein said porous mass further comprises at least one reinforcement material.

13. The method of claim 12, wherein said reinforcement material comprises at least one ceramic material.

14. The method of claim 12, wherein said reinforcement material comprises silicon carbide.

15. The method of claim 12, wherein said reinforcement material occupies from about 10 to about 90 percent by volume of said porous mass.

16. The method of claim 3, wherein said reinforcement material comprises a plurality of separate bodies of filler.

17. The method of claim 16, wherein said bodies of filler have a morphology selected from the group consisting of fibers, particles, whiskers, nanotubes, fiber tows and fabrics.

18. The method of claim 1, wherein said infiltrant material consists essentially of elemental silicon.

19. The method of claim 1, wherein said infiltrant material further comprises at least one other metallic constituent.

20. The method of claim 19, wherein said at least one other metallic constituent is selected from the group consisting of aluminum, copper and molybdenum.

21. The method of claim 19, wherein said at least one other metallic constituent comprises aluminum provided in an amount ranging from about 10 percent to about 80 percent by volume of said infiltrant material.

22. The method of claim 1, wherein said infiltrant material further comprises at least one source of boron.

23. The method of claim 22, wherein said reinforcement material comprises boron carbide.

24. (Canceled).

25. The method of claim 1, wherein said non-reactive environment comprises an environment selected from the group consisting of an inert gas and a vacuum.

26. The method of claim 25, wherein said vacuum is maintained below a residual pressure of about 50 mTorr.

27. The method of claim 1, wherein said porous mass comprises a preform.

28. The method of claim 27, wherein said preform is made to a desired shape by use of at least one traditional ceramic processing technique.

29. The method of claim 27, wherein, at least prior to said infiltrating step, said preform comprises at least one binder.

30. The method of claim 29, wherein said binder comprises at least one carbonaceous material.

31. The method of claim 29, wherein said binder comprises at least one carbohydrate.

32. The method of claim 30, wherein, prior to step infiltrating step, said preform is heated under conditions whereby said binder is pyrolyzed to a substance consisting predominantly of elemental carbon.

33. A method for making a composite material, comprising:
providing a porous mass;
providing an infiltrant material comprising silicon that is capable of wetting said porous mass when said infiltrant is molten;
heating said infiltrant material in a substantially non-reactive environment to a temperature above the liquidus temperature of said infiltrant material to form a molten infiltrant material, at least a portion of said heating being provided by microwave energy;
communicating said molten infiltrant material into contact with said porous mass; infiltrating said molten infiltrant material into said porous mass, and reacting at least a portion of said silicon with at least a portion of said carbon to form a composite body, and maintaining said microwave energy during at least a portion of said infiltrating and reacting.
